(19) United States
(12) Patent Application Publication
(10) Pub. No.: US 2017/0355324 A1
(43) Pub. Date: Dec. 14, 2017

(54) HEAT PROTECTOR FOR VEHICLE

(71) Applicants: Hyundai Motor India Engineering Pvt. Ltd., Hyderabad (IN); Hyundai Motor Company, Seoul (KR); Kia Motors Corporation, Seoul (KR)

(72) Inventors: Chintala Chytanya Kumar, Hyderabad (IN); Jong Seung Won, Hwaseong (KR); Man Seok Oh, Yongin (KR)

(21) Appl. No.: 15/258,608

(22) Filed: Sep. 7, 2016

(30) Foreign Application Priority Data
Jun. 9, 2016 (IN) 201641019847

(51) Int. Cl. B60R 13/08

(52) U.S. Cl. CPC B60R 13/0876

(57) ABSTRACT

A heat protector for a vehicle, includes: a first protrusion pattern having a plurality of protrusions formed with an elliptical shape, and the plurality of protrusions are radially disposed based on a first center point, and a second protrusion pattern having a second plurality of protrusions formed with an elliptical shape, and the second plurality of protrusions are radially disposed based on a second center point, wherein at least one protrusion of the first protrusion pattern is included in the second protrusion pattern.

### BACKGROUND

### (a) Field of the Invention

The present invention relates to a heat protector for a vehicle.

### (b) Description of the Related Art

Recently, research and development efforts by automotive manufacturers have focused on reducing the weight of vehicles by downsizing engines and increasing fuel efficiency, and also increasing the power of engines.

With an increase in efficiency of engines, an exhaust system including an exhaust manifold, an exhaust pipe, and a catalyst are maintained at higher temperatures than in the past, and accordingly, there is a need for increasing the performance of heat protectors (for example, heat shields and heat insulators).

A conventional heat protector typically is made of an aluminum-coated steel plate, but more recently, aluminum thin plates that are advantageous in weight and function have been used.

The surface shape of a conventional heat protector is formed as circular, hexagonal, or octagonal. However, the conventional shapes are unable to attain desired strength and absorb vibrations without a greater thickness of the heat protector, which leads to increases in weight and cost.

Therefore, there is a need to identify a surface pattern of the heat protector which can increase stiffness and a resonant frequency while maintaining a relatively small thickness.

The above information disclosed in this Background section is only for enhancement of understanding of the background of the invention and therefore it may contain information that does not form the prior art that is already known in this country to a person of ordinary skill in the art.

### SUMMARY

The present invention provides a heat protector for a vehicle having advantages of improved rigidity with a smaller thickness.

An exemplary embodiment of the present invention provides a heat protector for a vehicle, including: a first protrusion pattern configured to include a plurality of protrusions formed with an elliptical shape, and the plurality of protrusions are radially disposed based on a first center point, and a second protrusion pattern configured to include a second plurality of protrusions formed with an elliptical shape, and the second plurality of protrusions are radially disposed based on a second center point, wherein at least one protrusion of the first protrusion pattern is included in the second protrusion pattern.

The plurality of protrusions of the first protrusion pattern may include at least one first protrusion which a long axis of the elliptical shape is formed in a first direction, and at least one second protrusion which a long axis of the elliptical shape is formed in a second direction.

The second direction may be perpendicular to the first direction.

The at least one first protrusion or the at least one second protrusion may form another protrusion patterns with neighboring protrusions.

The plurality of protrusions of the second protrusion pattern may include at least one third protrusion which a long axis of the elliptical shape is formed in the first direction, and at least one fourth protrusion which a long axis of the elliptical shape is formed in the second direction.

The at least one first protrusion may be included in at least one third protrusion of the second protrusion pattern.

A short axis of the elliptical shape of the at least one first protrusion is horizontally formed with the long axis of the elliptical shape of the at least one fourth protrusion, and a short axis of the elliptical shape of the at least one second protrusion is horizontally formed with a short axis of the elliptical shape of the at least one fourth protrusion.

According to the present invention for achieving the object, by forming an embossing of elliptical shape and forming protrusion patterns of four petal pattern, it is possible to improve rigidity with a smaller thickness, reduce weight and cost of the heat protector, and improve durability.

### BRIEF DESCRIPTION OF THE DRAWINGS

FIG. 1 is a schematic view of pattern structures formed on a heat protector for a vehicle according to an exemplary embodiment of the present invention.

FIG. 2 is a schematic view of a first protrusion pattern of an A portion of FIG. 1.

FIG. 3 is a schematic view of a cross-section of the first protrusion pattern of FIG. 2.

FIG. 4 is a schematic view of a second protrusion pattern of the A portion of FIG. 1.

FIG. 5 is a schematic view comparing a long axis and a short axis of protrusions.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

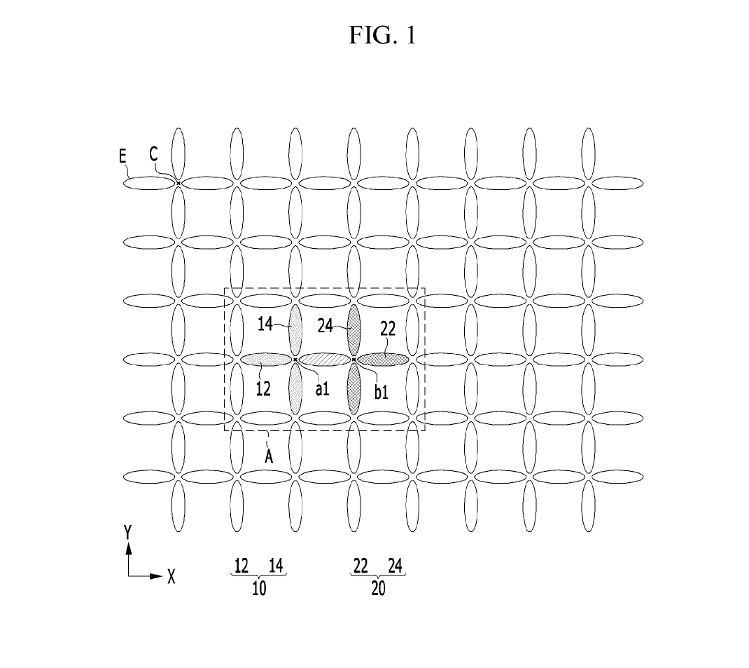

A heat protector for a vehicle will now be described with reference to FIGS. 1 to 5.

FIG. 1 is a schematic view of pattern structures formed on a heat protector for a vehicle according to an exemplary embodiment of the present invention. In this case, for convenience of explanation, a configuration of the heat protector for a vehicle according to the exemplary embodiment of the present invention is schematically illustrated, but the heat protector is not limited thereto.

Referring to FIG. 1, a plurality of protrusions E formed with an elliptical shape are formed on a surface of the heat protector for the vehicle according to an exemplary embodiment of the present invention. Herein, a long axis of the elliptical shape of some in the plurality of protrusions E is formed in parallel with a horizontal direction X. A long axis of the elliptical shape of the remaining protrusions in the plurality of protrusions E is formed in parallel with a vertical direction Y.

The protrusions E are radially formed based on a center point C, and neighboring four protrusions form a predetermined pattern.

For example, a first protrusion pattern 10 includes a plurality of protrusions 12 and 14 formed with an elliptical shape. The protrusions 12 and 14 of the first protrusion pattern 10 are radially disposed based on a first center point a1.

A second protrusion pattern 20 includes a plurality of protrusions 22 and 24 formed with an elliptical shape. The protrusions 22 and 24 of the second protrusion pattern 20 are radially disposed based on a second center point b1.

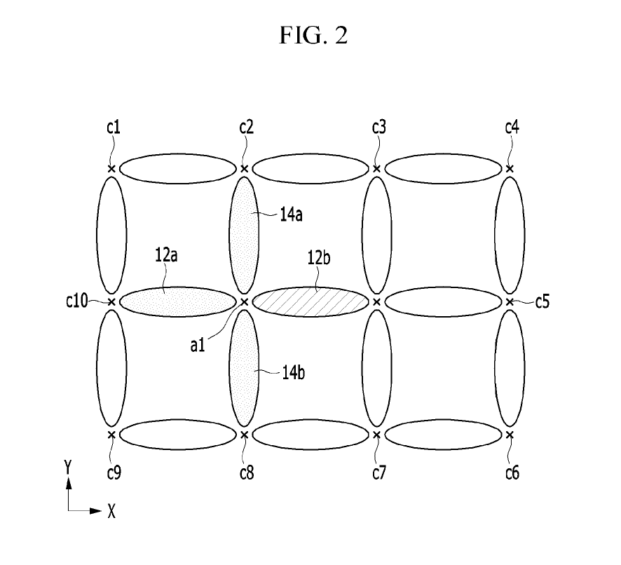

FIG. 2 is a schematic view of a first protrusion pattern of an A portion of FIG. 1.

Referring to FIG. 2, the first protrusion pattern 10 includes the first protrusion 12 and the second protrusion 14. And, the first protrusion 12 and the second protrusion 14 of the first protrusion pattern 10 are radially disposed with the first center point a1.

The first protrusion 12 includes protrusions 12a and 12b formed with the elliptical shape. A long axis of the elliptical shape of the protrusions 12a and 12b is formed in a first direction. The second protrusion 14 includes protrusions 14a and 14b formed with the elliptical shape. A long axis of the elliptical shape of the protrusions 14a and 14b is formed in a second direction. In particular, the first direction corresponds to the horizontal direction X, ant the second direction corresponds to the vertical direction Y. That is, the first direction and the second direction are perpendicular to each other.

Therefore, the protrusion 12a and 12b of the first protrusion 12 and the protrusion 14a and 14b of the second protrusion 14 are radially disposed based on the first center point a1, and form the first protrusion pattern 10.

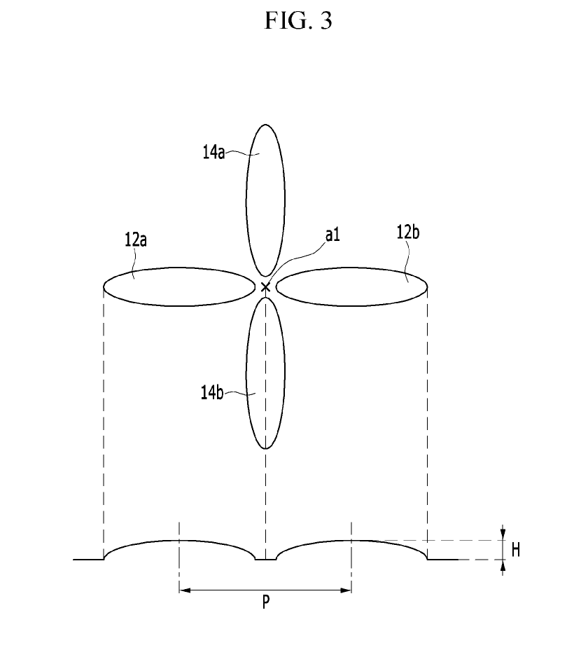

FIG. 3 is a schematic view of a cross-section of the first protrusion pattern of FIG. 2.

Referring to FIG. 3, the protrusions 12a and 12b of the first protrusion pattern 10 are upwardly protruded to be convex. As provided herein, P is a horizontal distance between the center of protrusions 12a and 12b, and H is a protruded height of the protrusions 12a and 12b.

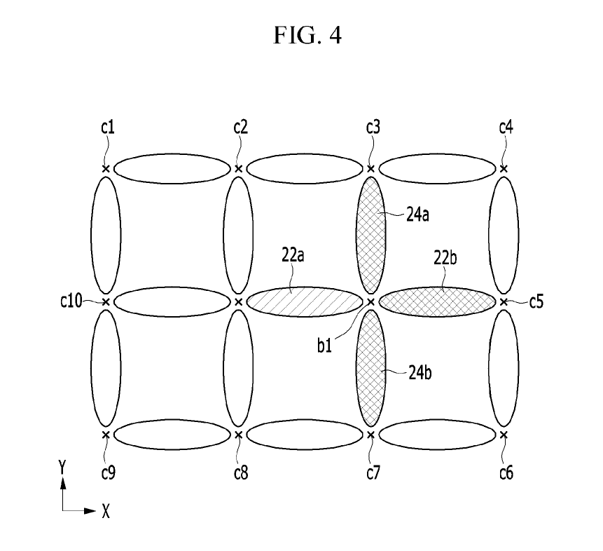

FIG. 4 is a schematic view of a second protrusion pattern of the A portion of FIG. 1.

Referring to FIG. 4, the second protrusion pattern 20 includes a third protrusion 22 and a fourth protrusion 24. The third protrusion 22 and fourth protrusion 24 of the second protrusion pattern 20 are radially disposed with the second center point b1.

The third protrusion 22 includes protrusions 22a and 22b formed with the elliptical shape. A long axis of the elliptical shape of the protrusions 22a and 22b is formed in the first direction. The fourth protrusion 24 includes protrusions 24a and 24b formed with the elliptical shape. A long axis of the elliptical shape of the protrusions 24a and 24b is formed in the second direction.

The protrusion 22a and 22b of the third protrusion 22 and the protrusion 24a and 24b of the fourth protrusion 24 are radially disposed based on the second center point b1, and form the second protrusion pattern 20.

The protrusion 12b of the first protrusion 12 is included in the third protrusion 22 of the second protrusion pattern 20. Therefore, the protrusion 12b of the first protrusion pattern 10 may be the protrusion 22a of the second protrusion pattern 20.

That is, the neighboring four protrusions based on the corresponding center point form a protrusion pattern. For example, the protrusions 12 and 14 of the first protrusion pattern 10 and protrusions 22 and 24 of the second protrusion pattern 20 may respectively form different protrusion patterns based on adjacent center points c1 to c10.

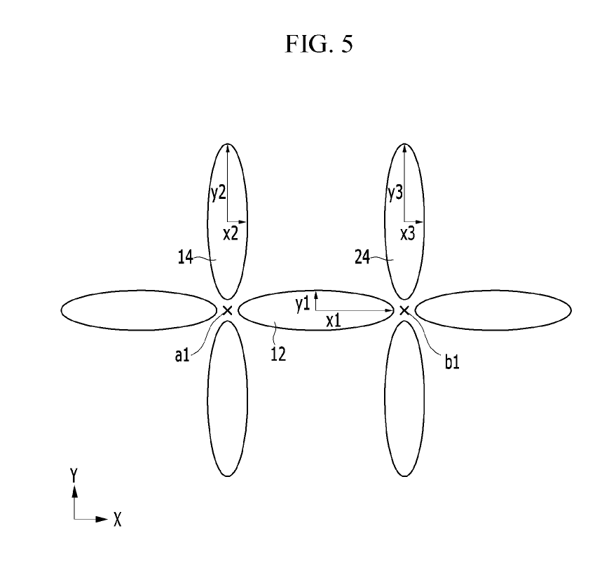

FIG. 5 is a schematic view comparing a long axis and a short axis of protrusions.

Referring to FIG. 5, a short axis y1 of the elliptical shape of the first protrusion 12 is parallel with a long axis y3 of the elliptical shape of the fourth protrusion 24. Also, a short axis x2 of the elliptical shape of the second protrusion 14 may be parallel with a short axis of the elliptical shape of the fourth protrusion 24.

According to the above-described structure, the heat protector for the vehicle according to an exemplary embodiment of the present invention can increase a resonant frequency as compared to the conventional art and reduce the noise when a thickness of the heat protector is similar to that in the conventional art. Also, the heat protector for the vehicle according to an exemplary embodiment of the present invention may increase the resonant frequency and maintain the noise when the thickness of the heat protector is decreased.

As described, the heat protector for the vehicle according to an exemplary embodiment of the present invention forms an embossing of elliptical shape and forms protrusion patterns of four petal pattern. Therefore, it is possible to improve rigidity with a smaller thickness, reduce weight and cost of the heat protector, and improve durability.

The foregoing exemplary embodiments of the present invention are not implemented only by an apparatus and a method, and therefore may be realized by programs realizing functions corresponding to the configuration of the exemplary embodiment of the present invention or recording media on which the programs are recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A heat protector for a vehicle, comprising:
a first protrusion pattern configured to include a plurality of protrusions formed with an elliptical shape, and the plurality of protrusions are radially disposed based on a first center point, and
a second protrusion pattern configured to include a second plurality of protrusions formed with an elliptical shape, and the second plurality of protrusions are radially disposed based on a second center point,
wherein at least one protrusion of the first protrusion pattern is included in the second protrusion pattern,
wherein the plurality of protrusions of the first protrusion pattern includes:
at least one first protrusion which a long axis of the elliptical shape is formed in a first direction, and
at least one second protrusion which a long axis of the elliptical shape is formed in a second direction,
wherein the second direction is perpendicular to the first direction,
wherein the at least one first protrusion or the at least one second protrusion forms another protrusion pattern with neighboring protrusions, and
wherein the plurality of protrusions of the second protrusion pattern includes:
at least one third protrusion in which a long axis of the elliptical shape is formed in the first direction, and
at least one fourth protrusion in which a long axis of the elliptical shape is formed in the second direction.

2.-5. (canceled)

6. The heat protector of claim 1, wherein the at least one first protrusion is included in at least one third protrusion of the second protrusion pattern.

7. The heat protector of claim 6, wherein:
a short axis of the elliptical shape of the at least one first protrusion is horizontally formed with the long axis of the elliptical shape of the at least one fourth protrusion, and
a short axis of the elliptical shape of the at least one second protrusion is horizontally formed with a short axis of the elliptical shape of the at least one fourth protrusion.
